(19) United States
(12) Patent Application Publication
(10) Pub. No.: US 2025/0108561 A1
(43) Pub. Date: Apr. 3, 2025

(54) METHODS AND SYSTEMS FOR ADDITIVE FABRICATION OF PARTS FROM A LIGHT-SCATTERING BUILD MATERIAL

(71) Applicant: FORMLABS, INC., Somerville, MA (US)

(72) Inventors: Thomas Orr, Cambridge, MA (US); Zachary Perlmutter, Belmont, MA (US)

(73) Assignee: FORMLABS, INC., Somerville, MA (US)

(21) Appl. No.: 18/903,745

(22) Filed: Oct. 1, 2024

Related U.S. Application Data
(60) Provisional application No. 63/541,934, filed on Oct. 2, 2023.

(51) Int. Cl. B29C 64/255; B29C 64/124; B33Y 10/00; B33Y 30/00

(52) U.S. Cl. CPC B29C 64/255; B29C 64/124; B33Y 10/00; B33Y 30/00; B29K 2823/16; B29K 2867/003

(57) ABSTRACT

Techniques are described for fabricating parts in an additive fabrication device from a light-scattering build material, such as ceramic build materials. An additive fabrication device may comprise a container for holding a photo-polymerizable build material containing a light-scattering species such as ceramic particles. The bottom of the tank may comprise one or more light-absorbing additives that absorb a portion of the actinic radiation used to cure the build material. The one or more light-absorbing additives may include an absorptive dye, including inorganic pigments like carbon black, organic dyes, or other species.

### CROSS-REFERENCE TO RELATED APPLICATIONS

The present application claims the benefit under 35 U.S.C. § 119(e) of U.S. Provisional Patent Application No. 63/541,934, filed Oct. 2, 2023, titled “Improved Methods and Systems for Printing Light Scattering Resin in an Additive Fabrication Device,” which is hereby incorporated by reference in its entirety.

### FIELD OF INVENTION

The present disclosure relates generally to the field of additive fabrication and, more particularly, to a method and system for fabricating parts in an additive fabrication device from a light-scattering build material.

### BACKGROUND

Additive fabrication, e.g., 3-dimensional (3D) printing, provides techniques for fabricating objects, typically by causing portions of a build material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering or combinations thereof. Many additive fabrication techniques build parts by forming successive layers, which are typically cross-sections of the desired object. Typically, each layer is formed such that it adheres to either a previously formed layer or a substrate upon which the object is built.

### SUMMARY

According to some aspects, the techniques described herein relate to an additive fabrication device configured to form layers of solid material on a build platform by curing liquid photopolymer, each layer of material being formed so as to contact a container in addition to a surface of the build platform and/or a previously formed layer of material, wherein the additive fabrication device includes: a container including a bottom surface that includes at least one polymer and at least one additive; and at least one energy source configured to direct actinic radiation through the bottom surface of the container to cure liquid photopolymer held by the container, wherein the at least one additive in the bottom surface of the container is configured to partially absorb transmission of the actinic radiation directed through the bottom surface of the container.

According to some aspects, the techniques described herein relate to a method of fabricating parts with an additive fabrication device, the additive fabrication device configured to form layers of solid material on a build platform by curing liquid photopolymer, each layer of material being formed so as to contact a container in addition to a surface of the build platform and/or a previously formed layer of material, wherein the method includes: supplying a photopolymer into a container that includes a bottom surface that includes at least one polymer and at least one light-absorbing additive; and directing actinic radiation from at least one energy source through the bottom surface of the container, thereby curing a region of the liquid photopolymer held by the container, wherein no more than 60% of actinic radiation incident on the bottom surface of the container is transmitted through the bottom surface of the container.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIGS. 1A-1C are perspective views of an illustrative additive fabrication system, depicting three different configurations during fabrication, according to some embodiments;

FIG. 2 depicts a cross-sectional view of an illustrative stereolithography (SLA) container holding a photocurable build material, according to some embodiments;

FIG. 3 depicts a comparison between a 3D model and the expected shape of a fabricated part that would be produced from a light-scattering build material, according to some embodiments;

FIG. 4 depicts a cross-sectional view of an illustrative stereolithography container comprising one or more light-absorbing additives, according to some embodiments;

FIG. 5 depicts a cross-sectional view of an illustrative stereolithography container comprising an anti-reflective coating, according to some embodiments;

FIG. 6 depicts a cross-sectional view of an illustrative stereolithography container in which an energy source is arranged directly adjacent to the container, according to some embodiments;

FIG. 7 depicts a cross-sectional view of an illustrative stereolithography container with a thickness configured to reduce scattered light rays from re-entering the build material, according to some embodiments;

FIG. 8 is a block diagram of a system suitable for practicing aspects of the

disclosure, according to some embodiments; and

FIG. 9 illustrates an example of a computing system environment on which aspects of the disclosure may be implemented.

### DETAILED DESCRIPTION

In additive fabrication, a desired part may be fabricated by forming successive layers of material on top of one another. For example, in stereolithography (SLA), a part may be fabricated by successively forming thin layers of a polymer by curing portions of a photocurable build material, typically first onto a substrate and then one on top of another.

One potential application of SLA may be to fabricate parts from a ceramic build material (which may herein refer to any build material that comprises a ceramic component). Ceramics are designed and engineered for high-performance applications in various industries, and often have exceptional mechanical, thermal, electrical, and chemical properties, making them suitable for specialized and demanding applications. Fabricating ceramic parts (which herein may refer to any parts that comprise a ceramic component, including fully ceramic parts) offers several significant advantages and benefits such as allowing complex geometries production and design flexibility, reduced material waste, cost-effectiveness for small batch production, etc.

However, fabricating parts from ceramic build materials via SLA presents several challenges, one of which is the phenomenon of light scattering. Unlike resin photopolymers typically used in SLA, ceramic build materials exhibit much greater light-scattering properties, which significantly impacts the resolution and surface quality of fabricated parts. Generally, the scattering of light within the ceramic build material during fabrication leads to reduced fidelity and resolution in the resultant parts.

Another challenge in fabricating parts from ceramic build materials via SLA arises from the high viscosity of ceramic materials. Unlike resin photopolymers typically used in SLA, ceramic build materials are often highly viscous, making it challenging to achieve uniform layer deposition and proper leveling of the build material. The high viscosity of a ceramic build material can impede the smooth flow and leveling required for precise layer formation, leading to uneven surfaces, structural defects, and compromised mechanical properties in the printed objects.

The inventors have recognized and appreciated techniques for fabricating parts in an additive fabrication device from a light-scattering build material such as, but not limited to, ceramic build materials. In particular, the inventors have recognized and appreciated that one of the primary causes of reduced quality when fabricating parts from a light-scattering build material is light being scattered within the build material back into the container holding the build material. Some of this light may be subsequently reflected or scattered within the body of the container and be directed back into the build material. As a result, locations within the build material that are not intended to receive light, and be cured, can nonetheless be partially or fully cured. Typical liquid photopolymers used in SLA such as resins, generally do not exhibit this problem to a meaningful extent because the amount of such scattering is small and most incident radiation is absorbed within the resin. However, when loading a build material with a ceramic material or other component that exhibits greater light-scattering properties, the detrimental effect on the quality of fabricated parts can be significant. While this can be partially mitigated by the inclusion of absorbing species into the build material, this hinders the overall depth to which light can penetrate into the resin, resulting in poor print reliability.

According to some embodiments, a container in an additive fabrication device may include at least one light-absorbing additive. For instance, the container may be formed from a material that includes at least one light-absorbing additive, and/or may include a surface layer that comprises at least one light-absorbing additive. The additive fabrication device may be configured so that the container holds a photocurable build material (e.g., a ceramic build material) and may be operated so that at least one energy source (e.g., a light source such as an LED screen, or a laser) directs actinic radiation (e.g., visible light, UV light, infrared light, etc.) through the bottom of the container to cure regions of the build material in a plurality of layers, and thereby fabricate one or more parts. The at least one light-absorbing additive may inhibit transmission of the actinic radiation through the container to such an extent that a significant fraction (e.g., at least 20%, 30%, 40% or 50%) of the actinic radiation incident on the bottom of the container is absorbed, scattered, or otherwise blocked by the container. For instance, only around 20% to 60% of the actinic radiation that is incident on the bottom of the container may be transmitted through the container and onto the build material. Light that is subsequently reflected within the container passes through the light-absorbing additive twice, and typically at a shallower angle. This results in the light-absorbing additive absorbing a significantly higher fraction of off-angle scattered light than the initially supplied actinic radiation.

While blocking such a significant amount of actinic radiation may be considered generally undesirable, if at least one energy source of the additive fabrication device is configured to produce sufficiently intense actinic radiation, the portion of the actinic radiation transmitted through the container may nonetheless be enough to sufficiently cure the build material. Moreover, any actinic radiation that is reflected back into the body of the container may be highly inhibited from propagating through the body of the container and back into the build material due to the at least one light-absorbing additive.

According to some embodiments, at least one light-absorbing additive may be provided as part of a container in numerous ways. In some embodiments, the container (or at least a portion of the container through which actinic radiation is directed during fabrication) is formed from a material that comprises the at least one light-absorbing additive. In some embodiments, the container may comprise a film (e.g., as the bottom surface, or part of the bottom surface, of the container), and the film may be formed from a material that comprises at least one light-absorbing additive. In some embodiments, the container may comprise multiple films (e.g., layered together as the bottom surface, or part of the bottom surface, of the container), and one (or more) of the films may be formed from a material that comprises at least one light-absorbing additive. In some embodiments, the container may comprise multiple films (e.g., layered together as the bottom surface, or part of the bottom surface, of the container), and at least one light-absorbing additive may be arranged between adjacent films of the multiple films.

In the description below, references to light-absorbing materials, or the absorbing or blocking of light more generally, will be understood to refer to inhibiting transmission of the actinic radiation that is utilized in an additive fabrication device to cure a photocurable material. In some cases, such actinic radiation may not include visible light, and may for instance include ultraviolet light and/or infrared light. Similarly, references to the scattering of light, or to a light-scattering build material, refer to scattering of actinic radiation or light derived therefrom in an additive fabrication device, and may refer to scattering of visible or non-visible wavelengths of light. It may also include fluorescence when the fluoresced wavelength is still capable of initiating photocuring of the build material. Fluorescence may occur since some light-absorbing additive described here (e.g., dyes) may limit the penetration of actinic radiation into the build material and re-emit that energy at a slightly higher wavelength.

Following below are more detailed descriptions of various concepts related to, and embodiments of, techniques for fabricating parts in an additive fabrication device from a light-scattering build material. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

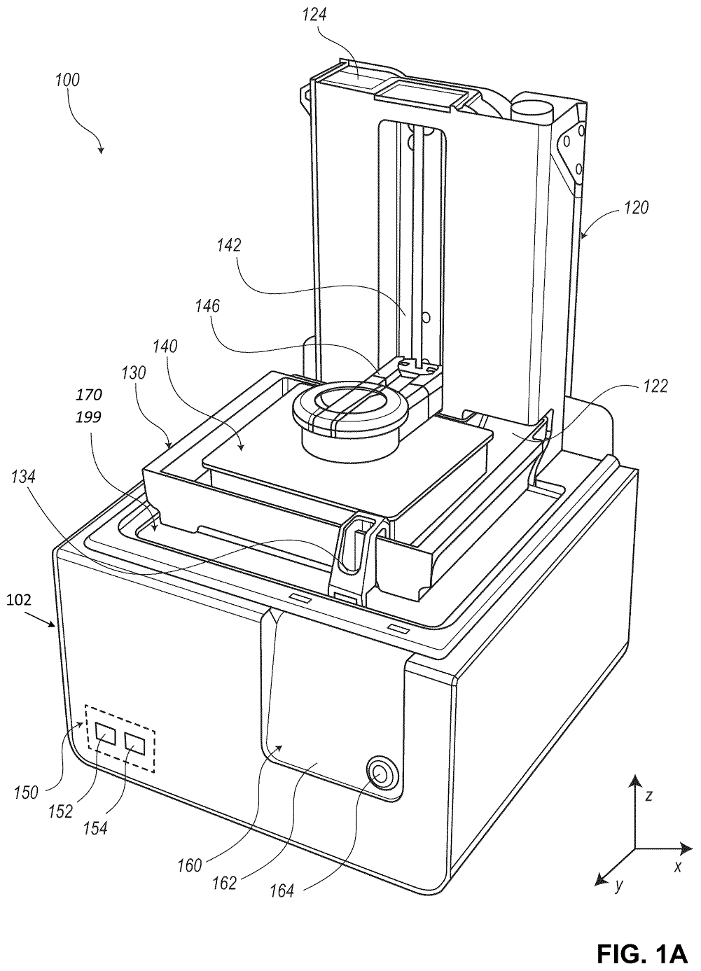

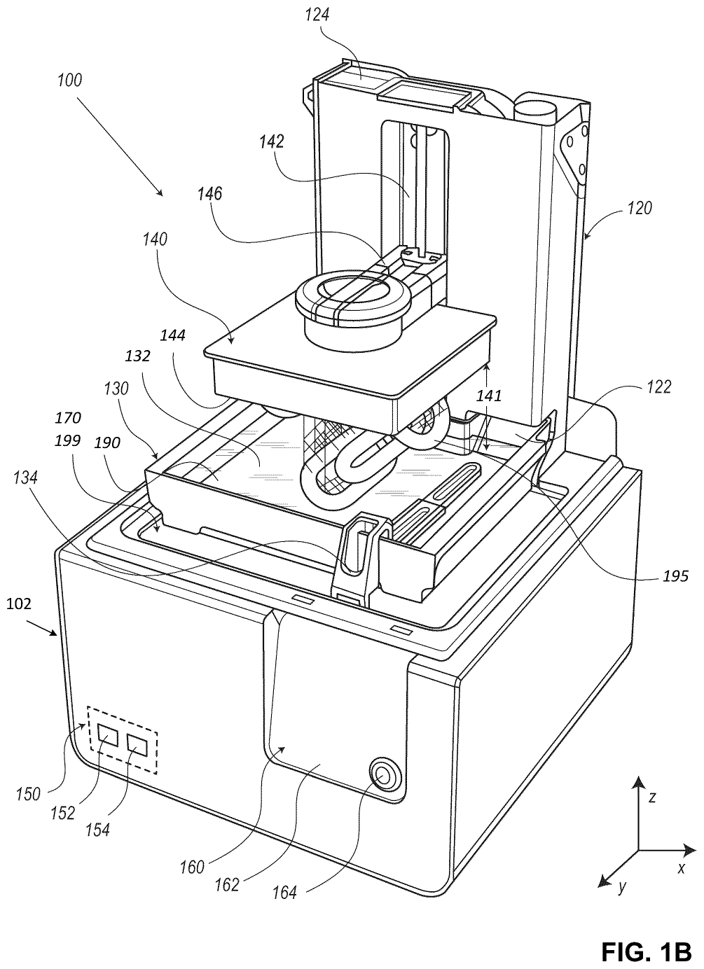

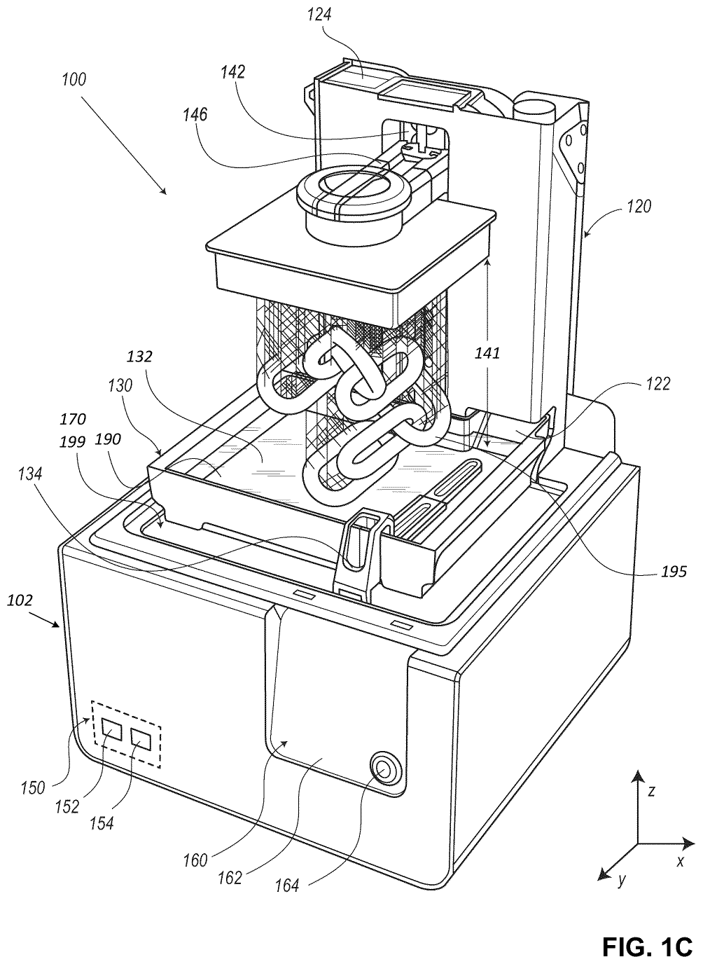

To provide an example of an additive fabrication device suitable for practicing the techniques described herein, FIGS. 1A-1C depict an additive fabrication device 100. In the example of FIGS. 1A-1C, an additive fabrication device 100, such as a stereolithographic printer, includes a base 102 and a dispensing system 120 coupled to the base 102. The base 102 supports a container 130 configured to receive a photocurable build material from the dispensing system 120. In some embodiments, the photocurable build material comprises one or more liquid photopolymers in addition to one or more fillers. In some embodiments, the one or more liquid photopolymers comprise a photopolymer resin.

In the example of FIGS. 1A-1C, the additive fabrication device 100 further includes a build platform 140 positioned above the container 130 and operable to traverse a vertical axis (e.g., z-axis) between an initial position (FIG. 1A) adjacent to a bottom surface 132 of the container 130 and a finished position (FIG. 1C) spaced apart from the bottom surface 132 of the container 130.

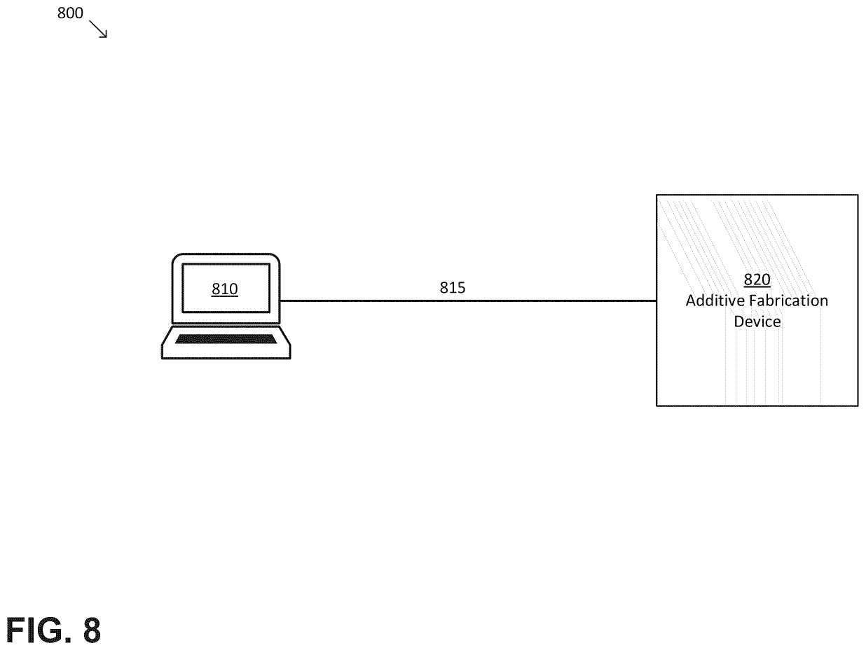

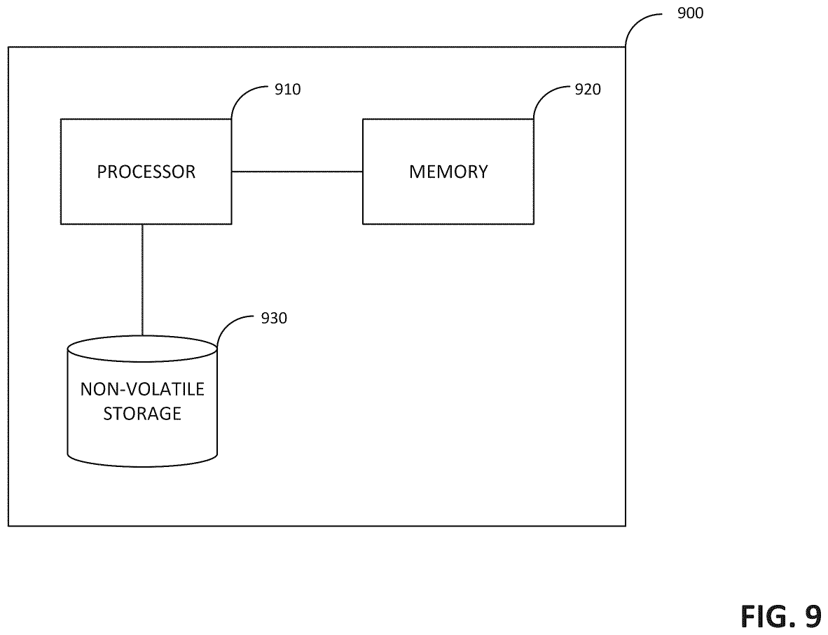

The base 102 of the additive fabrication device 100 may house various mechanical, optical, electrical, and electronic components operable to fabricate objects using the device. In the illustrated example, the base 102 includes a computing system 150 including data processing hardware 152 and memory hardware 154 (an example of such a computing system is described below in relation to FIG. 9). The data processing hardware 152 is configured to execute instructions stored in the memory hardware 154 to perform computing tasks related to activities (e.g., movement and/or printing based activities) for the additive fabrication device 100. The computing system 150 may be configured to communicate with a remote system (e.g., a remote computer/server or a cloud-based environment), as shown and described below in relation to FIG. 8.

The base 102 may further include a control panel 160 connected to the computing system 150. The control panel 160 includes a display 162 configured to display operational information associated with the additive fabrication device 100 and may further include an input device 164, such as a keypad or selection button, for receiving commands from a user. In some embodiments, the display is a touch-sensitive display providing a graphical user interface configured to receive the user commands from the user in addition to, or in lieu of, the input device 164.

In the example of FIGS. 1A-1C, the base 102 houses a curing system 170 configured to transmit actinic radiation into the container 130 to incrementally cure layers of the photocurable build material contained within the container 130. The curing system 170 may include a projector or other energy source configure to emit actinic radiation at a wavelength (or wavelengths) suitable to cure the photocurable build material within the container. Thus, an energy source, or operation of the energy source, may be selected to match the desired photocurable build material to be used for fabricating an object 195 (which may also be referred to herein as a “part”). In the example of FIG. 1A-1C, the curing system 170 includes a liquid crystal panel 199 for curing the photocurable build material within the container 130.

As shown in the example of FIGS. 1A-1C, the container 130 is arranged on top of the base 102 proximate to the curing system 170 and is configured to receive a supply of a photocurable build material 190 from the dispensing system 120. The dispensing system 120 may include an internal reservoir 124 providing an enclosed space for storing the photocurable build material until the photocurable build material is needed in the container 130. The dispensing system 120 further includes a dispensing nozzle 122 in communication with the container 130 to selectively supply the photocurable build material 190 from the internal reservoir 124 to the container 130.

In the example of FIGS. 1A-1C, the build platform 140 is movable along a vertical track or rail 142 oriented along the z-axis direction such that base-facing build surface 144 of the build platform 140 is positionable at a target distance 141 along the z-axis from the bottom surface 132 of the container 130. The target distance 141 may be selected based on a desired thickness of a layer of solid material to be produced on the build surface 144 of the build platform 140 or onto a previously formed layer of the object being fabricated. In some implementations, the build platform 140 is removable from the additive fabrication device 100. For instance, the build platform 140 may be attached to the rail 142 by an arm 146 (e.g., pressure fit or fastened onto) and may be selectively removed from the additive fabrication device 100 so that a fabricated object 195 attached to the build surface 144 can be removed via the techniques described above.

In the example of FIGS. 1A-1C, the bottom surface 132 of container 130 may be transparent to the actinic radiation that is output from by the curing system 170 located within the base 102, such that photocurable build material located between the bottom surface 132 of the container 130 and either the build surface 144 of the build platform 140 or a previously-formed layer of an object, may be exposed to the radiation. Upon exposure to such actinic radiation, the liquid photopolymer may undergo a chemical reaction, sometimes referred to as “curing,” that substantially solidifies and attaches the exposed photocurable build material to the build surface 144 of the build platform 140 or to a bottom surface of an object being fabricated thereon.

Following the curing of a layer of the fabrication material, the build platform 140 may incrementally advance upward along the rail 142 in order to reposition the build platform 140 for the formation of a new layer and/or to impose separation forces upon any bond with the bottom surface 132 of container 130. In addition, the container 130 is mounted onto the support base such that the additive fabrication device 100 may move the container 130 along a horizontal axis of motion (e.g., x-axis), the motion thereby advantageously introducing additional separation forces in at least some cases. A wiper 134 is additionally provided, capable of motion along the horizontal axis of motion and which may be removably or otherwise mounted onto the base 102 or the container 130.

With continued reference to FIGS. 1A-1C, the additive fabrication device 100 is shown at different stages of the fabrication process. For example, at FIG. 1A, the additive fabrication device is shown in an initial state prior to dispensing the photocurable build material 190 into the container 130 from the reservoir 124 of the dispensing system 120. Upon receipt of fabrication instructions, the additive fabrication device 100 positions the build surface 144 of the build platform 140 at an initial distance 141 from the bottom surface 132 of the container 130 corresponding to a thickness of the first layer of photocurable build material 190 to be cured. The curing system 170 then emits an actinic radiation profile (i.e., an image) corresponding to the profile of the current layer of the object 195 to cure the current layer. Upon curing of the current layer, the build platform 140 incrementally advances upward to the next build position. The distance of each advancement increment corresponds to a thickness of the next layer to be fabricated. The curing system 170 then projects the profile of the layer corresponding to the new position. The new layer is cured on a bottom surface of the previous layer. The curing and advancing steps repeat until the build platform 140 reaches the final position (as shown in FIG. 1C) corresponding to the finished object 195.

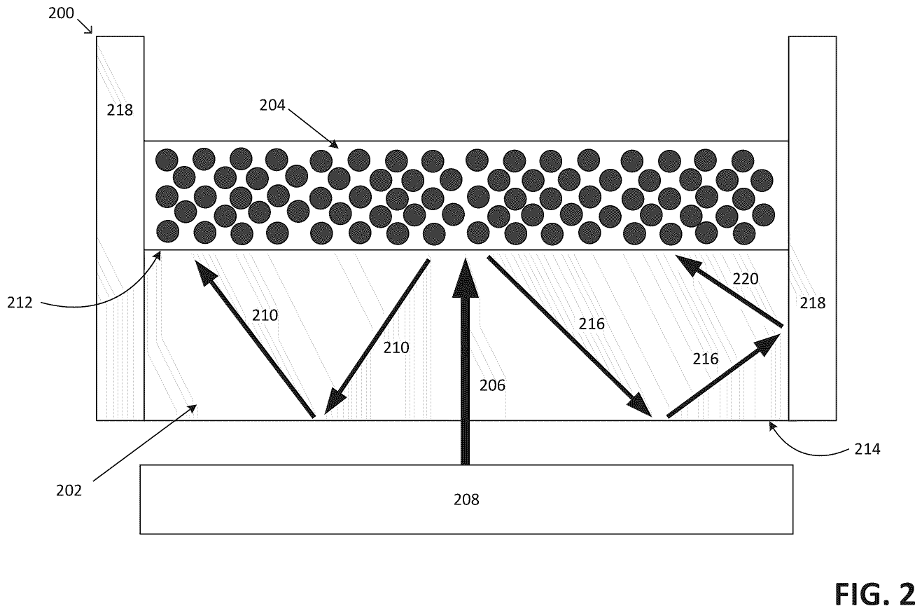

FIG. 2 depicts a cross-sectional view of an illustrative stereolithography (SLA) container holding a photocurable build material, according to some embodiments. In the example of FIG. 2, container 200 is holding a photocurable build material 204. Container 200 may for instance be utilized as the container 130 in the illustrative additive fabrication device of FIGS. 1A-1C.

In the example of FIG. 2, the container 200 contains (is holding) a light-scattering photocurable build material 204, such as a ceramic resin. The container 200 includes two walls 218 and a bottom of the container 202 between the walls, which is transparent or significantly transparent to actinic radiation 206 (e.g., allowing at least a portion of the incoming actinic radiation 206 to pass through the bottom of the container 202). The actinic radiation 206 is emitted from an energy source 208 (e.g., a light engine) and directed towards the container 200. Upon entering the container 200, the actinic radiation 206 photocures the build material 204 (or a part thereof).

In the example of FIG. 2, the build material 204 comprises densely packed particles mixed with (e.g., in a matrix of) a photocurable liquid (e.g., a photocurable resin). The particles have a higher refractive index than the surrounding liquid, and so when the actinic radiation 206 encounters the particles, it is not absorbed uniformly but is instead deflected in multiple directions. This scattering phenomenon is particularly pronounced in build materials containing significant loading of fillers such as ceramic particles or TiO₂ pigments. The scattered actinic radiation 210 then follows the paths described below, leading to unintended curing and a loss of precision in the final printed object. This scattering effect is a significant challenge when fabricating parts that contain a ceramic or another heavy material with stereolithography.

Due to the tendency of the build material 204 to scatter light, a portion of the actinic radiation 206 is scattered back towards the surface of the bottom of the container 202. This scattered actinic radiation 210 re-enters the bottom of the container 202 at the container-build material interface 212, which is the interface between the bottom of the container 202 and the build material 204.

The scattered actinic radiation 210 then travels through the bottom of the container 202 and hits the container-air interface 214, which is the interface between the bottom of the container 202 and the air beneath the container. Due to the phenomenon of internal reflection (e.g., total internal reflection), the scattered actinic radiation 210 is reflected upwards, back towards the container-material interface 212.

Upon reaching the container-build material interface 212, the reflected actinic radiation 216 re-enters the build material 204. This re-entered actinic radiation 216 can cause additional curing of the build material 204, potentially outside the intended target area. This unintended curing can lead to a loss of precision in the fabricated object, and can cause other issues such as deformation, degradation of the build material, or structural instability.

In some cases, reflected actinic radiation 216 can also travel laterally within the bottom of the container 202. This occurs when the reflected actinic radiation 216, instead of immediately re-entering the build material 204, continues to travel within the bottom of the container 202 and reaches the container's side wall 218. Upon reaching the container's side wall 218, the reflected actinic radiation 216 is again reflected due to the phenomenon of internal reflection. This results in a laterally reflected actinic radiation 220 that travels along the bottom of the container 202 and reaches another area of the container-build material interface 212.

When the laterally reflected actinic radiation 220 re-enters the build material 204 at this new location, it can cause additional unintended curing of the build material 204. This further exacerbates the issues of precision and accuracy in the final printed object.

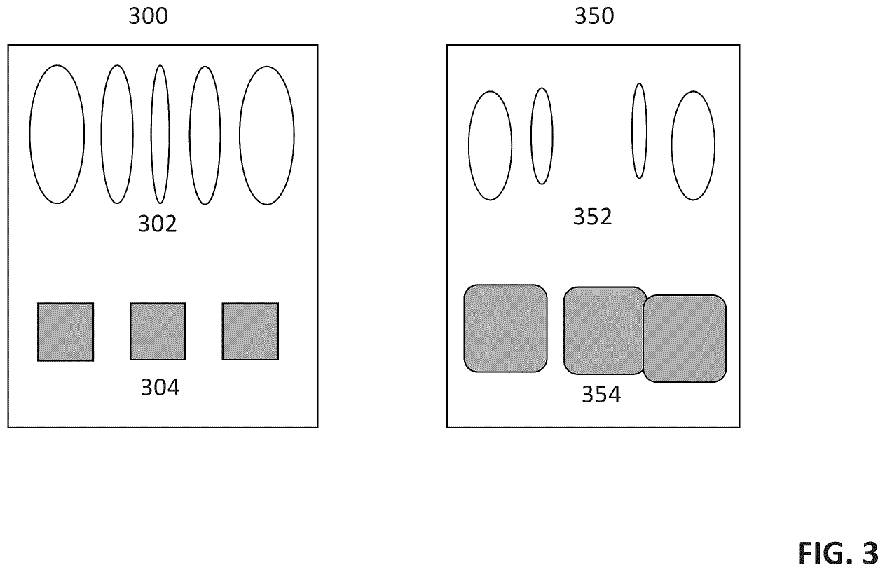

As such, the use of light-scattering build materials, such as ceramic resin, in SLA printing presents unique challenges. The light-scattering behavior exhibited by these materials can lead to unintended curing and a loss of precision, which can negatively impact the quality and accuracy of the final printed object. This can result in uneven curing and lead to structural instability or deformation in the printed object. The scattered energy can also interfere with the curing process in adjacent layers, affecting the overall integrity and quality of the printed object. This is generally observed as a feature-size dependent variation in apparent cure energy: large features will act as if they were dosed with considerably more energy than smaller features, since much of the reflected backscatter ends up back within the part. An example of this phenomenon is shown in FIG. 3.

FIG. 3 depicts a comparison between a 3D model 300 and the expected shape of a fabricated part 350 that would be produced from a light-scattering build material, such as ceramic resin. The 3D model 300, depicted on the left, features a series of oval holes 302 (negative features) and a series of square protrusions 304 (positive features). The fabricated part 350, depicted on the right, is the expected result of using conventional SLA fabrication with a light-scattering build material.

The oval holes 302 in the 3D model 300 are designed with specific dimensions and spacing. However, in the fabricated part 350, these oval holes 352 are fabricated to be smaller than intended. In fact, the smallest hole in the 3D model 300 is not produced at all in the fabricated part 350. This reduction in size and disappearance of smaller holes is a result of the light scattering effect described above in relation to FIG. 2, which can cause unintended curing outside the target area, leading to a loss of precision.

Similarly, the square protrusions 304 in the 3D model 300 are designed with sharp corners and specific positions. However, in the fabricated part 350, these squares 354 are formed as larger protrusions, and with rounded corners. Furthermore, the position of the squares 354 in the fabricated part 350 is shifted compared to their intended position in the 3D model 300. In some instances, the squares 354 even appear connected, forming a larger, irregular shape.

These discrepancies between the 3D model 300 and the fabricated part 350 are due to the light scattering effect described above in relation to FIG. 2. The scattering causes the actinic radiation to cure the resin outside the intended target area, leading to deformation, positional shifts, and loss of precision in the final printed object. This demonstrates the unique challenges presented by the use of light-scattering build materials in SLA printing.

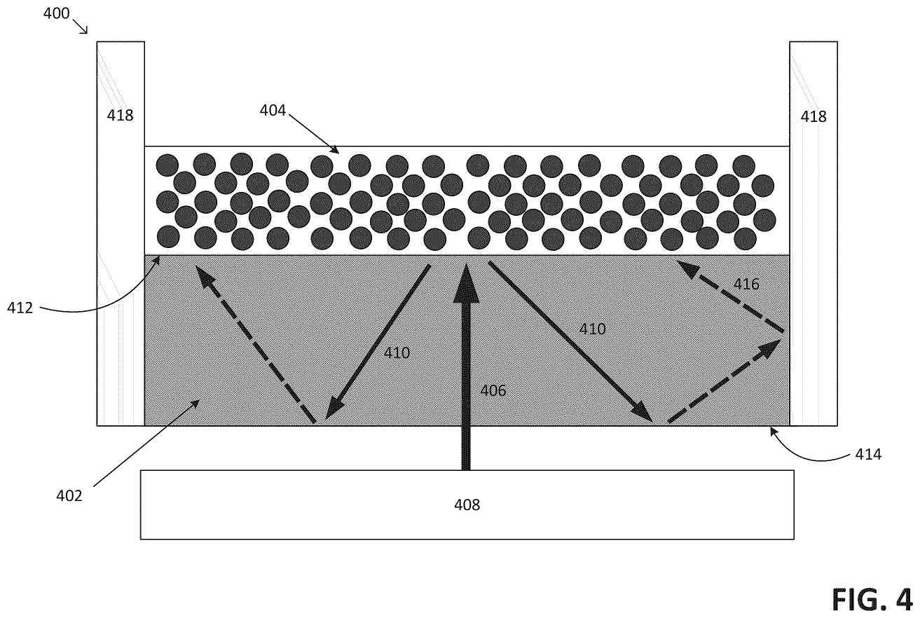

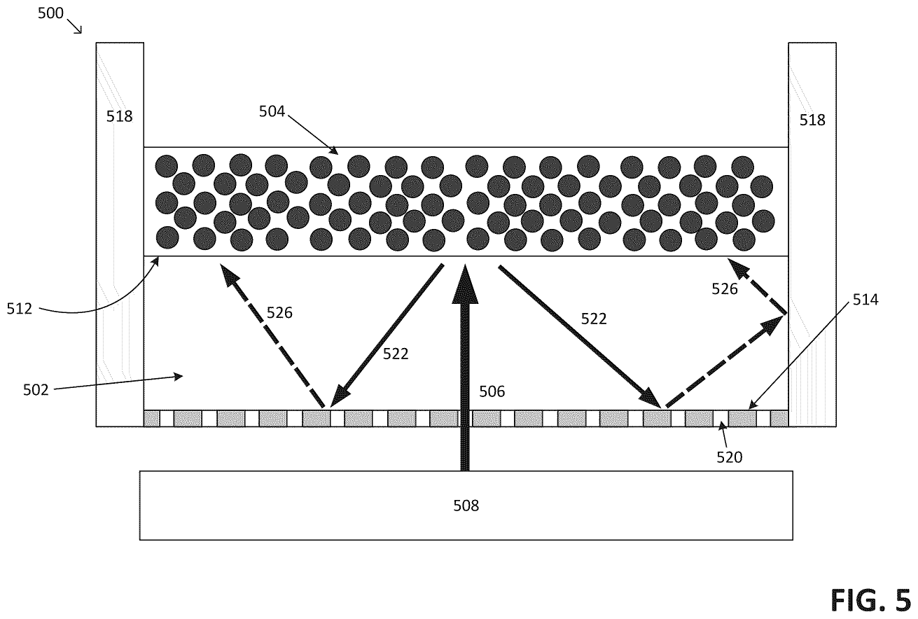

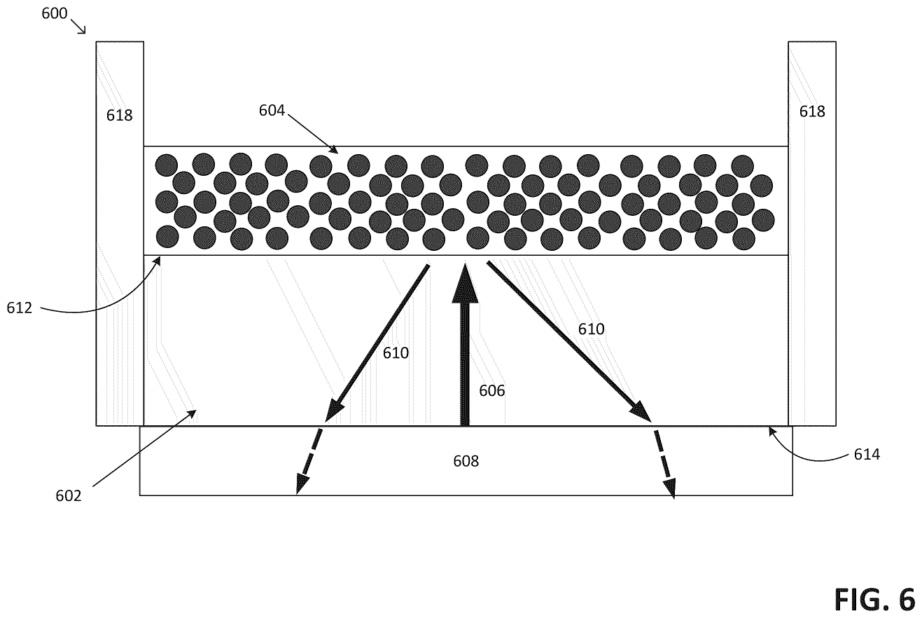

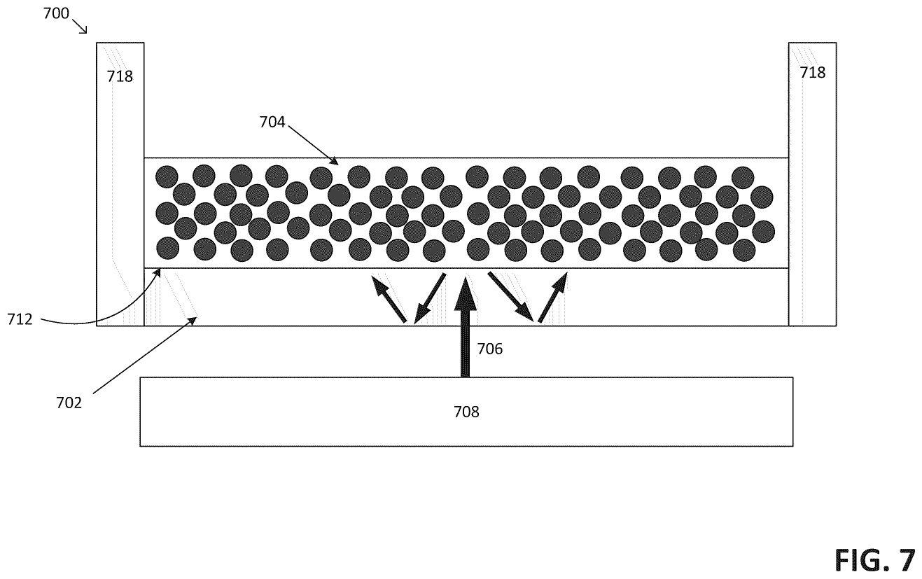

To achieve high precision and accuracy, it is highly desirable to minimize the above-described interaction of backscattered actinic radiation with the container. As described in various embodiments below, the inventors have recognized and appreciated various approaches to reduce the extent to which actinic radiation scatters within the container, and/or to reduce the effects thereof. These techniques include providing a material that contains at least one light-absorbing additive as part of the container (see FIG. 4, described below), providing an anti-reflective coating on the container (see FIG. 5, described below), arranging the source of actinic radiation to be in optical contact with the container, without an air gap (e.g., close to, or directly in contact with, the container) (see FIG. 6, described below), and fabricating the container with a thinner bottom surface (see FIG. 7, described below). Each of these techniques may be combined in any combination.

FIG. 4 depicts a cross-sectional view of an illustrative stereolithography container comprising one or more light-absorbing additives, according to some embodiments. In the example of FIG. 4, container 400 is holding a photocurable build material 404. Container 400 may for instance be utilized as the container 130 in the illustrative additive fabrication device of FIGS. 1A-1C.

In the example of FIG. 4, the container 400 contains (is holding) a light-scattering photocurable build material 404, such as a ceramic resin. The container 400 includes two walls 418, and a bottom of the container 402 between the walls that is transparent or significantly transparent to actinic radiation 406 (e.g., allowing at least a portion of the incoming actinic radiation 406 to pass through the bottom of the container 402). The actinic radiation 406 is emitted from an energy source 408 (e.g., a light engine) and directed towards the container 400. Upon entering the container 400, the actinic radiation 406 photocures the build material 404 (or a portion thereof).

In the example of FIG. 4, the bottom of the container 402 comprises at least one light-absorbing additive. In some embodiments, the bottom of the container comprises, or is formed from, at least one polymer and the at least one light-absorbing additive. For example, the bottom of the container (and in some cases other portions of the container) may be formed from, or may comprise, a layer of a thermoplastic polymer comprising the at least one light-absorbing additive as a component of the layer (e.g., the at least one light-absorbing additive may be mixed with the molten polymer and the combination used to form the layer).

Due to the tendency of the build material 404 to scatter light, a portion of the actinic radiation 406 is scattered back into the bottom of the container 402. This scattered actinic radiation 410 re-enters the bottom of the container 402 at the container-material interface 412, which is the interface between the container 402 and the build material 404.

However, unlike the configuration in FIG. 2, the scattered actinic radiation 410 is absorbed, scattered, attenuated or otherwise blocked by the at least one light-absorbing additive within the bottom of the container 402. This blocking of scattered actinic radiation 410 significantly weakens its intensity by the time it reaches the container-air interface 414 and is reflected back into the build material 404 (as indicated by the dashed light rays in FIG. 4). As a result, the potential for unintended curing of the build material 404 outside the intended target area is significantly reduced.

In cases where scattered actinic radiation 410 is reflected from the bottom of the container 402 and then again at the side wall 418 of the container (actinic radiation 416), this twice-reflected actinic radiation 416 may re-enters the build material 404, but due to the extended path of travel, this twice-reflected actinic radiation 416 undergoes significant attenuation. The at least one light-absorbing additive within the bottom of the container 402 absorbs a substantial portion of this energy during its journey. As a result, the intensity of the twice-reflected actinic radiation 416 that re-enters the build material 404 is considerably reduced.

This attenuation of the twice-reflected actinic radiation 416 further reduces the potential for unintended curing of the build material 404. The extended path of travel and the absorption by the at least one light-absorbing additive within the bottom of the container 402 may cause only a minimal amount of actinic radiation to re-enter the build material 404, thereby maintaining the precision and accuracy of the final printed object and reducing the risk of deformation or structural instability.

The above-described configuration of the SLA container 400 may dramatically reduce the negative effects of scattering in SLA printing of ceramic or other light-scattering build materials. By absorbing the scattered actinic radiation 410, the at least one light-absorbing additive in the bottom of the container 402 helps to maintain the precision and accuracy of the final printed object, and reduces the risk of deformation or structural instability. This configuration thus addresses the unique challenges presented by the use of light-scattering build materials in SLA printing.

The at least one light-absorbing additive may be provided as part of the bottom of container 402 in various ways. In some embodiments, the bottom of the container 402 may comprise a film (e.g., as the bottom surface, or part of the bottom surface, of the container), and the film may be formed from a material that comprises at least one light-absorbing additive. In some embodiments, the bottom of the container 402 may comprise multiple films (e.g., layered together as the bottom surface, or part of the bottom surface, of the container), and one of the films may be formed from a material that comprises at least one light-absorbing additive. In some embodiments, the bottom of the container 402 may comprise multiple films (e.g., layered together as the bottom surface, or part of the bottom surface, of the container), and at least one light-absorbing additive may be arranged between adjacent films of the multiple films (e.g., as an adhesive layer that adheres the adjacent films together). The walls 418 of the container may be formed from the same, or a different material to the bottom of the container 402.

According to some embodiments, the bottom of the container 402 may comprise a lower film and an upper film adhered to one another, wherein the lower film comprises at least one light-absorbing additive. For example, the lower film may comprise, or may be formed from, polyethylene terephthalate (PET) and the at least one light-absorbing additive (e.g., carbon black); and the upper film may comprise, or may be formed from, fluorinated ethylene propylene (FEP).

Irrespective of how at least one light-absorbing additive is provided as part of the bottom of the container 402, according to some embodiments a light-absorbing additive may be an inorganic pigment. These are typically compounds that have strong absorption properties. One example is carbon black, which is a form of elemental carbon that has a very high surface area to volume ratio. It has an excellent ability to absorb both light and infrared heat energy. Other illustrative inorganic pigments that can be used as a light-absorbing additive include one or more iron oxides (e.g., FeO, FE₃O₄), chromium oxide (e.g., CrO, Cr₂O₃), and titanium dioxide (TiO₂), each of which has unique absorption characteristics.

In some embodiments, a light-absorbing additive may be an organic dye. These are carbon-based compounds that are capable of absorbing specific wavelengths of light. Organic dyes can be tailored to absorb actinic radiation at specific wavelengths, making them highly versatile. Examples of organic dyes include azo dyes, anthraquinone dyes, and phthalocyanine dyes.

In some embodiments, a light-absorbing additive may some other material that is capable of absorbing actinic radiation. For example, certain types of nanoparticles, such as gold or silver nanoparticles, can be used as a light-absorbing additive due to their strong absorption properties. Additionally, certain types of polymers or copolymers can be used, which can be designed to have specific absorption characteristics.

In some embodiments, a light-absorbing additive may exhibit dichroism. Some of the above examples of light-absorbing additives may exhibit dichroism, although other additives that exhibit dichroism may additionally, or alternatively, be provided as a light-absorbing additive. In a dichroic material, absorption of light differs depending on the orientation of the material with respect to the polarization axis of incident light. Examples of such materials include iodine impregnated PVA or elongated silver nanoparticles. In cases where the actinic radiation is polarized (e.g., in additive fabrication devices in which the energy source is a laser system or an LCD screen), it may be advantageous for a light-absorbing additive to perform dichroic absorbing (e.g., as a polarizer) to improve transmission of the polarized primary radiation relative to the amount of attenuation of the unpolarized scattered light.

The bottom of the container 402 may comprise any one or more of the above examples of light-absorbing additives, in any combination, to effectively block actinic radiation, thereby improving the precision and accuracy of the SLA printing process. The choice of light-absorbing additives can be tailored to the specific requirements of the printing process, including the type of build material being used, the wavelength of the actinic radiation, and the desired properties of the final printed object.

According to some embodiments, the wavelengths of actinic radiation that may be produced by the energy source 408 may range from ultraviolet to visible light, such as between 350 to 450 nanometers. When printing ceramic resins, it may be advantageous to use even higher wavelengths, up through the IR spectrum (e.g., 700-1000 nanometers), to further reduce the amount of scattered light, since scattering is typically inversely proportional to the wavelength of incident light. The selection of one or more light-absorbing additives for the bottom of the container is therefore significantly influenced by this range. The absorptive material is desirably capable of effectively absorbing actinic radiation within the specific wavelength range produced by the energy source 408. The pigments, organic dyes, or other light-absorbing additives can be selected to absorb light within this specific wavelength range.

In some cases, the build material may fluoresce light at a different wavelength than that supplied by the energy source. The fluoresced light so produced may be capable of further curing the build material. In this case, it may be advantageous to select the one or more light-absorbing additives to more completely absorb this fluoresced radiation.

According to some embodiments, the amount of one or more light-absorbing additives provided within the bottom of the container, and/or the thickness of the container or layer of the container that includes one or more light-absorbing additives, can greatly affect the amount of actinic radiation that is blocked by the container. For instance, a higher concentration or a thicker layer of a material comprising one or more light-absorbing additives can lead to more effective blocking of scattered actinic radiation, thereby reducing the risk of unintended curing of the build material, but may also limit the amount of actinic radiation that is transmitted through the bottom of the container and is incident on the build material. Therefore, the concentration or thickness of the absorptive material is desirably optimized to effectively block scattered actinic radiation while still allowing sufficient actinic radiation to reach the build material and initiate the intended curing process.

In some embodiments, the intensity of actinic radiation that is transmitted through the bottom of the container 402 and onto the build material 404 is greater than or equal to 10%, 20%, 30%, 40%, 50%, 60% or 70% of the intensity of the actinic radiation that is incident on the lower face of the bottom of the container. In some embodiments, the intensity of actinic radiation that is transmitted through the bottom of the container 402 and onto the build material 404 is less than or equal to 80%, 70%, 60%, 50%, 40%, 30% or 20% of the intensity of the actinic radiation that is incident on the lower face of the bottom of the container. Any suitable combinations of the above-referenced ranges are also possible (e.g., the intensity of actinic radiation that is transmitted through the bottom of the container 402 and onto the build material 404 is greater or equal to 20% and less than or equal to 80% of the intensity of the actinic radiation that is incident on the lower face of the bottom of the container, etc.). Any light that is not transmitted may be absorbed, scattered or otherwise attenuated by the bottom of the container.

In some embodiments, the energy source 408 may comprise a laser with a galvanometer (galvo) scanning system. This setup involves a laser beam that is directed and controlled by galvanometer mirrors to selectively cure the build material layer by layer. The precise control offered by galvo scanning allows for high-resolution printing and intricate details.

In some embodiments, the energy source 408 may comprise an LCD (liquid crystal display) with LED (light-emitting diode) array. In this configuration, an LCD panel acts as a mask, selectively blocking or allowing light to pass through. The LED array provides the light source, which is then modulated by the LCD panel to cure the build material. This approach offers a cost-effective solution with good resolution and the ability to cure larger areas simultaneously.

In some embodiments, the energy source 408 may comprise a Digital Micromirror Device (DMD), which comprises an array of micro mirrors that can be individually tilted to reflect or block light. By controlling the orientation of the mirrors, specific areas of the build material can be exposed to the curing light, enabling precise curing patterns. DMD-based SLA printers are known for their high-speed printing capabilities and can achieve rapid layer-by-layer curing.

FIG. 5 depicts a cross-sectional view of an illustrative stereolithography container comprising an anti-reflective coating, according to some embodiments. In the example of FIG. 5, container 500 is holding a photocurable build material 504. Container 500 may for instance be utilized as the container 130 in the illustrative additive fabrication device of FIGS. 1A-1C.

In the example of FIG. 5, the container 500 contains (is holding) a light-scattering photocurable build material 504, such as a ceramic resin. The container 500 includes two walls 518 and a bottom of the container 502 between the walls, which is transparent or significantly transparent to actinic radiation 506 (e.g., allowing at least a portion of the incoming actinic radiation 506 to pass through the container 502). The actinic radiation 506 is emitted from an energy source 508 (e.g., a light engine) and directed towards the container 500. Upon entering the container 500, the actinic radiation 506 photocures the build material 504 (or a portion thereof). Any of the illustrative types of energy sources described above in relation to energy source 408 may be implemented as the energy source 508 in the example of FIG. 5.

In the example of FIG. 5, the bottom of the container 502 is coated with a layer 520 that limits the transmission/reflection angle of incident light. In some embodiments, the angle dependent transmissive layer 520 may employ micro-optic technology, and may for example be a micro-louver film. This angle dependent transmissive layer 520 is positioned facing the energy source 508, and is configured to allow light to transmit through it at normal incident angles, while greatly reducing light transmitting through it, or reflecting from it, at non-normal incident angles.

As a result, when a portion of the actinic radiation 506 is scattered back towards the bottom of the container 502, the angle dependent transmissive layer 520 reduces the amount of scattered actinic radiation 522 that re-enters the bottom of the container 502 at the container-build material interface 512, which is the interface between the bottom of the container 502 and the build material 504. The scattered actinic radiation 522 that does re-enter the bottom of the container 502 then travels through the bottom of the container 502 and is incident on the container-air interface 514, which is the interface between the bottom of the container 502 and the air beneath the container. Due to the phenomenon of internal reflection, the scattered actinic radiation 522 is reflected upwards, back towards the container-build material interface 512. However, the angle dependent transmissive layer 520 again reduces the amount of reflected actinic radiation 526 that re-enters the build material 504.

This reduction in re-entered actinic radiation 526 minimizes additional curing of the build material 504 outside the intended target area. This results in a significant improvement in the precision of the final printed object, and reduces issues such as deformation or structural instability.

Therefore, the use of an angle dependent transmissive layer 520 in SLA printing with light-scattering build materials, such as ceramic resin, can effectively address the unique challenges presented by these materials. The angle dependent transmissive layer 520 reduces unintended curing and improves the precision, quality, and accuracy of the final printed object.

According to some embodiments, the angle dependent transmissive layer 520 is, or comprises, a micro-louver film. The structure of a micro-louver film comprises a multitude of precisely arranged louvers that are oriented in such a way that they allow light to pass through in a straight line, but deflect light that comes at an angle. In some embodiments, a micro-louver film may be configured to selectively pass through UV or near UV light while blocking other types of light. This optimization allows for precise control over the curing process and provides a greater amount of the desired wavelengths of light for fabrication. Furthermore, the micro-louver film can be easily replaced if needed, providing flexibility and convenience in maintaining the functionality of the container. This feature allows for efficient maintenance and potential upgrades to the film technology as advancements are made in the field. While micro-louver films are commercially available, they may not be optimized for light transmission at or near 405 nm due to the display industry's desire for limiting blue light.

FIG. 6 depicts a cross-sectional view of an illustrative stereolithography container in which an energy source is arranged directly adjacent to the container, according to some embodiments. In the example of FIG. 6, container 600 is holding a photocurable build material 604. Container 600 may for instance be utilized as the container 130 in the illustrative additive fabrication device of FIGS. 1A-1C.

In the example of FIG. 6, the container 600 contains (is holding) a light-scattering photocurable build material 604, such as a ceramic resin. The container 600 includes two walls 618 and a bottom of the container 602 between the walls, which is transparent or significantly transparent to actinic radiation 606 (e.g., allowing at least a portion of the incoming actinic radiation 606 to pass through the container 602). The actinic radiation 606 is emitted from an energy source 608 (e.g., a light engine) and directed towards the container 600. Upon entering the container 600, the actinic radiation 606 photocures the build material 604 (or a portion thereof). Any of the illustrative types of energy sources described above in relation to energy source 408 may be implemented as the energy source 608 in the example of FIG. 6.

In the example of FIG. 6, the energy source 608 is arranged directly adjacent to (e.g., contacting, in optical contact with) the bottom of the container 602. In some embodiments, the energy source 608 is an absorptive-type exposure mask, such as an LCD, which is directly optically coupled to the bottom of the container 602. In some embodiments, a polymer stabilized alignment (PSA) layer such as an acrylic or a low tack silicone PSA, and/or a liquid optical coupling gel, can be arranged between the energy source 608 and the bottom of the container 602 to provide coupling therebetween.

Due to the close attachment of the bottom of the container 602 to the energy source 608, the amount of actinic radiation 606 that is scattered back towards the build material 604 is reduced. This is because the close attachment of the bottom of the container 602 to the energy source 608 minimizes or removes the container-air interface, thereby reducing or eliminating the internal reflection of the scattered actinic radiation 610 at the interface 614. As a result, less actinic radiation is reflected upwards, back towards the container-material interface 612. This reduces the amount of actinic radiation that re-enters the build material 604, thereby minimizing additional curing of the build material 604 outside the intended target area. This improved configuration can lead to a significant increase in the precision of the final printed object, and can help to prevent issues such as deformation or structural instability.

FIG. 7 depicts a cross-sectional view of an illustrative stereolithography container with a thickness configured to reduce scattered light rays from re-entering the build material, according to some embodiments. In the example of FIG. 7, container 700 is holding a photocurable build material 704. Container 700 may for instance be utilized as the container 130 in the illustrative additive fabrication device of FIGS. 1A-1C.

In the example of FIG. 7, the container 700 contains (is holding) a light-scattering photocurable build material 704, such as a ceramic resin. The container 700 includes two walls 718 and a bottom of the container 702 between the walls, which is transparent or significantly transparent to actinic radiation 706 (e.g., allowing at least a portion of the incoming actinic radiation 706 to pass through the container 702). The actinic radiation 706 is emitted from an energy source 708 (e.g., a light engine) and directed towards the container 700. Upon entering the container 700, the actinic radiation 706 photocures the build material 704 (or a portion thereof). Any of the illustrative types of energy sources described above in relation to energy source 408 may be implemented as the energy source 708 in the example of FIG. 7.

In the example of FIG. 7, the bottom of the container 702 has a predefined thickness that is selected to increase the chance that a scattered light ray re-enters the container at a location within a predefined distance away from the original entry point, thus limiting the extent to which scattered light can spread out laterally within the bottom of the container.

As actinic radiation 706 emitted from an energy source 708 enters the container 700, it interacts with the light-scattering build material 704. Due to the scattering nature of the build material 704, a portion of the actinic radiation 706 is scattered back towards the bottom of the container 702 from the interface 712. However, instead of being completely blocked or significantly reduced, as in other examples described above, the scattered-reflected light rays are allowed to re-enter the bottom of the container 702. The predefined thickness of the bottom of the container 702 causes these scattered-reflected light rays to re-enter the container at a location within a minimized predefined distance away from the original entry point.

By controlling the distance at which the scattered-reflected light rays re-enter the container, the predefined thickness of the bottom of the container 702 helps to minimize unintended curing of the resin material 704 outside the intended target area. This further improves the precision, quality, and accuracy of the final printed object, reducing issues such as deformation or structural instability.

Therefore, the use of a bottom of the container with a predefined thickness in SLA printing with light-scattering build materials, such as ceramic resin, provides an effective solution to address the challenges presented by these materials. The predefined thickness of the bottom of the container increases the likelihood that scattered-reflected light rays re-enter the container within a predefined distance, minimizing unintended curing and enhancing the overall printing process.

In some embodiments, the described methods and/or systems described above in relation to FIGS. 1-7 can be used to produce wood-like objects with a wood dust blended resin.

This innovative formulation combines a base resin with wood dust and expandable microspheres, creating a unique blend that allows for the production of objects with a wood-like appearance and texture. The base resin used in this formula is a standard photopolymer resin, which is commonly used in SLA additive fabrication due to its excellent curing properties and compatibility with the SLA process. Any heat-resistant photopolymer resin can be used, such as Formlab's High Temp resin.

The wood dust filler is evenly dispersed within the base resin, providing the printed object with a natural, wood-like aesthetic. For example, the wood dust filler is dispersed evenly within the base resin through a thorough mixing process. This allows the wood particles to be uniformly distributed throughout the resin, resulting in a consistent wood-like appearance in the final print. The expandable microspheres, with particle sizes ranging from 10-100 microns, are also dispersed within the base resin. These microspheres are designed to expand when subjected to heat, mimicking the density and feel of real wood. After the additive fabrication process, the fabricated part is placed in an oven and heated between 100° C. to 300° C. for several minutes. This heat treatment causes the microspheres to expand (e.g., creating air pockets within the object), further enhancing the wood-like properties of the printed object. The formula is designed to be versatile and can replicate the properties of various types of wood. The type of wood dust used in the formula can be altered to mimic different types of wood. For instance, using oak wood dust would result in a print with the characteristics of oak, while using pine wood dust would create a print with the properties of pine. This versatility allows for a wide range of applications and customizations based on the user's specific needs. This wood-resin formula for SLA additive fabrication offers a revolutionary approach to creating realistic, wood-like prints.

In addition to the individual configurations described in FIG. 1A to FIG. 7, it should be noted that these configurations can be combined and used together to further enhance the performance of the stereolithography printer optimized for printing ceramic resin. For example, the light absorbing bottom of the container described in FIG. 4 can be utilized in conjunction with the micro-louver film described in FIG. 5, allowing for both reduction of scattered actinic radiation and absorption of unwanted light. Furthermore, the direct coupling of the light engine to the bottom of the container, as depicted in FIG. 6, can be implemented alongside the utilization of the thin film described in FIG. 7. This combination of configurations enables the printer to effectively minimize unintended curing, improve precision, and enhance the overall quality and accuracy of the final printed object. By cross-pollinating these various configurations, the printer can overcome the unique challenges presented by light-scattering resin material and achieve optimal printing results.

FIG. 8 is a block diagram of a system suitable for practicing aspects of the invention, according to some embodiments. System 800 illustrates a system suitable for generating instructions to perform additive fabrication by an additive fabrication device and subsequent operation of the additive fabrication device to fabricate a part. For instance, instructions to fabricate a part within an additive fabrication device that comprises any of the above-described containers may be generated by the system and provided to the additive fabrication device. Various parameters associated with fabricating parts may be stored by computing system 810 and accessed when generating instructions for the additive fabrication device 820.

According to some embodiments, computing system 810 may execute software that generates instructions for fabricating a part using an additive fabrication device, such that when said instructions are executed by the additive fabrication device the additive fabrication device performs a process of fabricating the part. Said instructions may be provided to an additive fabrication device, such as additive fabrication device 820, via link 815, which may comprise any suitable wired and/or wireless communications connection. In some embodiments, a single housing holds the computing system 810 and additive fabrication device 820 such that the link 815 is an internal link connecting two modules within the housing of system 800.

An illustrative implementation of a computer system 900 that may be used to control aspects of an additive fabrication device is shown in FIG. 9. The computer system 900 may include one or more processors 910 and one or more non-transitory computer-readable storage media (e.g., memory 920 and one or more non-volatile storage media 930). The one or more processors 910 may control writing data to and reading data from the memory 920 and the one or more non-volatile storage media 930 in any suitable manner, as the aspects of the disclosure described herein are not limited in this respect. To perform functionality and/or techniques described herein, the one or more processors 910 may execute one or more instructions stored in one or more computer-readable storage media (e.g., the memory 920, storage media, etc.), which may serve as non-transitory computer-readable storage media storing instructions for execution by the one or more processors 910.

In connection with techniques described herein, code used to, for example, generate instructions that, when executed by an additive fabrication device, fabricate one or more parts, or that otherwise control an additive fabrication device, may be stored on one or more computer-readable storage media of computer system 900. The one or more processors 910 may execute any such code to perform any of the above-described techniques as described herein. Any other software, programs or instructions described herein may also be stored and executed by computer system 900. It will be appreciated that computer code may be applied to any aspects of methods and techniques described herein.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as described above.

The terms “program,” “software,” and/or “application” are used herein in a generic sense to refer to any type of computer code or set of computer-executable instructions that can be employed to program a computer or other processor to implement various aspects of embodiments as described above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Having thus described several aspects of at least one embodiment of this disclosure, it is to be appreciated that various alterations, modifications, and improvements will readily occur to those skilled in the art. For instance, aspects of the techniques described herein may be combined in any of the following ways:

According to some aspects, the techniques described herein relate to a 3D printer tank for use in stereolithography (SLA) 3D printing, including: a tank body configured to hold a photo-polymerizable resin containing scattering species (e.g., ceramic particles); and a film disposed at a bottom of the tank body, wherein the film is configured to absorb a portion of actinic radiation used to cure the resin through the inclusion of an absorptive dye or pigment.

According to some aspects, the techniques described herein relate to a 3D printer tank, wherein the absorptive dye includes inorganic pigments (such as carbon black), organic dyes, or other species which absorbs actinic radiation.

According to some aspects, the techniques described herein relate to a 3D printer tank, wherein it works with a polarized light source (such as an LCD) and preferentially transmits light which is oriented along the light source polarization axis and absorbs unpolarized light. Exemplary absorbing systems may include a dye type or iodine type polarizer.

According to some aspects, the techniques described herein relate to a 3D printer tank, wherein the film includes one or more of a low surface-energy and/or oxygen permeable release layer such as a fluoropolymer or polymethylpentene, a mechanical reinforcing layer with a yield strength greater than 75 MPa (such as Biaxially Oriented Polyester), and an adhesive or tie layer, such as acrylic transfer adhesive 3M 8211. The dye may be incorporated into any of these layers through blending, or it may be provided as a coating on one of the layers.

According to some aspects, the techniques described herein relate to a 3D printer tank for use in stereolithography (SLA) 3D printing, including: a tank body configured to hold a photo-polymerizable resin containing ceramic particles; and a film disposed at a bottom of the tank body, wherein the film is configured to absorb a portion of actinic radiation, and wherein the film includes a micro-louver structure configured to provide small vertical absorption and large angled light absorption.

According to some aspects, the techniques described herein relate to a 3D printer tank for use in stereolithography (SLA) 3D printing of scattering materials, including: an absorptive type exposure mask, such as an LCD; a release layer such as a fluoropolymer or PMP polymer film that is directly optically coupled to the absorptive mask.

According to some aspects, the techniques described herein relate to a method of producing an object through an additive fabrication process, the method including: providing a 3D printer tank configured to hold a photo-polymerizable resin containing scattering species, wherein the resin tank includes a film configured to absorb a portion of actinic radiation used to cure the resin through the inclusion of an absorptive dye or pigment; loading the photo-polymerizable resin into the tank; and curing the photo-polymerizable resin with an actinic energy transmitted through the film.

According to some aspects, the techniques described herein relate to a method, wherein the absorptive dye includes inorganic pigments, organic dyes, or other species which absorbs actinic radiation.

According to some aspects, the techniques described herein relate to a method, wherein the 3D printer tank is configured to receive a polarized light source and preferentially transmits light which is oriented along the light source polarization axis and absorbs unpolarized light.

According to some aspects, the techniques described herein relate to a method, wherein the film includes one or more of a low surface-energy and/or oxygen permeable release layer, a mechanical reinforcing layer with a yield strength greater than 75MPa, and an adhesive or tie layer. The dye may be incorporated into any of these layers through blending, or it may be provided as a coating on one of the layers.

According to some aspects, the techniques described herein relate to a method of producing an object through an additive fabrication process, the method including: providing a 3D printer tank configured to hold a photo-polymerizable resin containing ceramic particles; disposing a film at a bottom of the 3D printer tank, wherein the film is configured to absorb a portion of actinic radiation, and wherein the film includes a micro-louver structure configured to provide small vertical absorption and large angled light absorption.

According to some aspects, the techniques described herein relate to a method of producing an object through an additive fabrication process, the method including: providing an absorptive type exposure mask; and providing a release layer that is directly optically coupled to the absorptive mask.

Aspect 1. An additive fabrication device configured to form layers of solid material on a build platform by curing liquid photopolymer, each layer of material being formed so as to contact a container in addition to a surface of the build platform and/or a previously formed layer of material, wherein the additive fabrication device comprises: a container comprising a bottom surface that comprises at least one polymer and at least one additive; and at least one energy source configured to direct actinic radiation through the bottom surface of the container to cure liquid photopolymer held by the container, wherein the at least one additive in the bottom surface of the container is configured to partially absorb transmission of the actinic radiation directed through the bottom surface of the container.

Aspect 2. The additive fabrication device of aspect 1, wherein the at least one additive in the bottom surface of the container is configured to partially absorb transmission of the actinic radiation directed through the bottom surface of the container such that between 20% and 80% of actinic radiation incident on the bottom surface of the container is transmitted through the bottom surface of the container onto the liquid photopolymer.

Aspect 3. The additive fabrication device of aspect 1, wherein the bottom surface of the container comprises a film, and wherein the film comprises the at least one polymer and the at least one additive.

Aspect 4. The additive fabrication device of aspect 1, wherein the bottom surface of the container comprises at least one film, and wherein the at least one film comprises the at least one polymer and the at least one additive.

Aspect 5. The additive fabrication device of aspect 4, wherein the at least one film includes a first film adhered to a second film, and wherein the second film comprises the at least one additive.

Aspect 6. The additive fabrication device of aspect 5, wherein the second film is arranged below the first film.

Aspect 7. The additive fabrication device of aspect 6, wherein the first film comprises polyethylene terephthalate (PET) and wherein the second film comprises fluorinated ethylene propylene (FEP).

Aspect 8. The additive fabrication device of aspect 1, wherein the bottom surface of the container comprises a first film comprising the at least one polymer, and wherein the at least one additive is provided as a layer over the first film.

Aspect 9. The additive fabrication device of aspect 8, wherein the bottom surface of the container further comprises a second film adhered to the first film.

Aspect 10. The additive fabrication device of aspect 9, wherein the first film comprises polyethylene terephthalate (PET) and wherein the second film comprises fluorinated ethylene propylene (FEP).

Aspect 11. The additive fabrication device of aspect 9, wherein the at least one additive is provided as a layer between the first film and the second film.

Aspect 12. The additive fabrication device of aspect 11, wherein the at least one additive is an adhesive layer that adheres the first film to the second film.

Aspect 13. The additive fabrication device of aspect 1, wherein the at least one additive comprises one or more inorganic pigments and/or one or more organic dyes.

Aspect 14. The additive fabrication device of aspect 13, wherein the at least one additive comprises carbon black, iron oxide, chromium oxide, and/or titanium dioxide.

Aspect 15. The additive fabrication device of aspect 13, wherein the at least one additive comprises one or more azo dyes, anthraquinone dyes, and/or phthalocyanine dyes.

Aspect 16. The additive fabrication device of aspect 13, wherein the at least one energy source is arranged in contact with the bottom surface of the container.

Aspect 17. The additive fabrication device of aspect 13, wherein the at least one energy source is arranged with an air gap between the at least one energy source and the bottom surface of the container.

Aspect 18. The additive fabrication device of aspect 13, wherein the at least one energy source is configured to produce polarized actinic radiation, and wherein the at least one additive exhibits dichroism.

Aspect 19. The additive fabrication device of aspect 1, wherein the at least one energy source is configured to produce actinic radiation with a wavelength between 350 nm and 450 nm.

Aspect 20. The additive fabrication device of aspect 1, wherein the at least one energy source is configured to produce actinic radiation with a wavelength between 700 nm and 1000 nm.

Aspect 21. A method of fabricating parts with an additive fabrication device, the additive fabrication device configured to form layers of solid material on a build platform by curing liquid photopolymer, each layer of material being formed so as to contact a container in addition to a surface of the build platform and/or a previously formed layer of material, wherein the method comprises: supplying a photopolymer into a container that includes a bottom surface that comprises at least one polymer and at least one light-absorbing additive; and directing actinic radiation from at least one energy source through the bottom surface of the container, thereby curing a region of the liquid photopolymer held by the container, wherein no more than 60% of actinic radiation incident on the bottom surface of the container is transmitted through the bottom surface of the container.

Aspect 22. The method of aspect 21, wherein the bottom surface of the container comprises a film, and wherein the film comprises the at least one polymer and the at least one light-absorbing additive.

Aspect 23. The method of aspect 21, wherein the bottom surface of the container comprises at least one film, and wherein the at least one film comprises the at least one polymer and the at least one light-absorbing additive.

Aspect 24. The method of aspect 23, wherein the at least one film includes a first film adhered to a second film, and wherein the second film comprises the at least one light-absorbing additive.

Aspect 25. The method of aspect 24, wherein the second film is arranged below the first film.

Aspect 26. The method of aspect 25, wherein the first film comprises polyethylene terephthalate (PET) and wherein the second film comprises fluorinated ethylene propylene (FEP).

Aspect 27. The method of aspect 21, wherein the at least one light-absorbing additive comprises one or more inorganic pigments and/or one or more organic dyes.

Aspect 28. The method of aspect 27, wherein the at least one light-absorbing additive comprises carbon black, iron oxide, chromium oxide, and/or titanium dioxide.

Aspect 29. The method of aspect 27, wherein the at least one light-absorbing additive comprises one or more azo dyes, anthraquinone dyes, and/or phthalocyanine dyes.

Aspect 30. The method of aspect 27, wherein the actinic radiation is directed through an air gap between the at least one energy source and the bottom surface of the container.

Such alterations, modifications, and improvements are intended to be part of this disclosure, and are intended to be within the spirit and scope of the disclosure. Further, though advantages of the present disclosure are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, aspects of the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. An additive fabrication device configured to form layers of solid material on a build platform by curing liquid photopolymer, each layer of material being formed so as to contact a container in addition to a surface of the build platform and/or a previously formed layer of material, wherein the additive fabrication device comprises:
a container comprising a bottom surface that comprises at least one polymer and at least one additive; and
at least one energy source configured to direct actinic radiation through the bottom surface of the container to cure liquid photopolymer held by the container,
wherein the at least one additive in the bottom surface of the container is configured to partially absorb transmission of the actinic radiation directed through the bottom surface of the container.

2. The additive fabrication device of claim 1, wherein the at least one additive in the bottom surface of the container is configured to partially absorb transmission of the actinic radiation directed through the bottom surface of the container such that between 20% and 80% of actinic radiation incident on the bottom surface of the container is transmitted through the bottom surface of the container onto the liquid photopolymer.

3. The additive fabrication device of claim 1, wherein the bottom surface of the container comprises a film, and wherein the film comprises the at least one polymer and the at least one additive.

4. The additive fabrication device of claim 1, wherein the bottom surface of the container comprises at least one film, and wherein the at least one film comprises the at least one polymer and the at least one additive.

5. The additive fabrication device of claim 4, wherein the at least one film includes a first film adhered to a second film, and wherein the second film comprises the at least one additive.

6. The additive fabrication device of claim 5, wherein the second film is arranged below the first film.

7. The additive fabrication device of claim 6, wherein the first film comprises polyethylene terephthalate (PET) and wherein the second film comprises fluorinated ethylene propylene (FEP).

8. The additive fabrication device of claim 1, wherein the bottom surface of the container comprises a first film comprising the at least one polymer, and wherein the at least one additive is provided as a layer over the first film.

9. The additive fabrication device of claim 8, wherein the bottom surface of the container further comprises a second film adhered to the first film.

10. The additive fabrication device of claim 9, wherein the first film comprises polyethylene terephthalate (PET) and wherein the second film comprises fluorinated ethylene propylene (FEP).

11. The additive fabrication device of claim 9, wherein the at least one additive is provided as a layer between the first film and the second film.

12. The additive fabrication device of claim 11, wherein the at least one additive is an adhesive layer that adheres the first film to the second film.

13. The additive fabrication device of claim 1, wherein the at least one additive comprises one or more inorganic pigments and/or one or more organic dyes.

14. The additive fabrication device of claim 13, wherein the at least one additive comprises carbon black, iron oxide, chromium oxide, and/or titanium dioxide.

15. The additive fabrication device of claim 13, wherein the at least one additive comprises one or more azo dyes, anthraquinone dyes, and/or phthalocyanine dyes.

16. A method of fabricating parts with an additive fabrication device, the additive fabrication device configured to form layers of solid material on a build platform by curing liquid photopolymer, each layer of material being formed so as to contact a container in addition to a surface of the build platform and/or a previously formed layer of material, wherein the method comprises:
supplying a photopolymer into a container that includes a bottom surface that comprises at least one polymer and at least one light-absorbing additive; and
directing actinic radiation from at least one energy source through the bottom surface of the container, thereby curing a region of the liquid photopolymer held by the container, wherein no more than 60% of actinic radiation incident on the bottom surface of the container is transmitted through the bottom surface of the container.

17. The method of claim 16, wherein the bottom surface of the container comprises a first film adhered to a second film, and wherein the second film comprises the at least one polymer and the at least one light-absorbing additive.

18. The method of claim 16, wherein the at least one light-absorbing additive comprises one or more inorganic pigments and/or one or more organic dyes.

19. The method of claim 16, wherein the at least one light-absorbing additive comprises carbon black, iron oxide, chromium oxide, and/or titanium dioxide.

20. The method of claim 16, wherein the at least one light-absorbing additive comprises one or more azo dyes, anthraquinone dyes, and/or phthalocyanine dyes.
